(19) United States
(12) Patent Application Publication
(10) Pub. No.: US 2005/0280309 A1
(43) Pub. Date: Dec. 22, 2005

(54) Wheel for tire

(76) Inventor: Atsushi Tanno, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/523,789

(22) PCT Filed: Aug. 19, 2003
(86) PCT No.: PCT/JP03/10442

§ 371 Date: Feb. 9, 2005

(30) Foreign Application Priority Data
Aug. 23, 2002 (JP) 2002244124

(51) Int. Cl. B60B 21/00

(52) U.S. Cl. 301/95.109

(57) ABSTRACT

A tire wheel comprising a disk and a rim for mounting a pneumatic tire joined to the peripheral edge of the disk. The rim includes a rim body joined to the disk and rim flanges joined to both width direction sides of the rim body. The disk is offset to one side with respect to the width direction center of the rim. The rim body has a rim body portion extending from a join position between the disk and the rim body to a boundary position between the rim body and the rim flange on the other side. The rim body portion consists of three equal sections into which the rim body portion is equally divided along the center axis of rotation of the wheel. The equal section positioned closer to the rim flange on the other side is thinner in average rim thickness.

### TECHNICAL FIELD

The present invention relates to tire wheels, and more particularly, to a tire wheel which can be lightened without suffering deterioration of road noise.

### TECHNICAL BACKGROUND

In recent years, with lightening of vehicles, tire wheels have been lightened. The ways of lightening include, for example, a way of reducing the thickness of the disc or rim of a wheel. The conventional lightening is performed by averagely reducing the thickness of the disc or rim.

Tire wheels which are lightened as described above, however, have natural frequencies which moved into a lower frequency band, whereby the natural frequency of the wheel is close to the natural frequency of a pneumatic tire assembled to the wheel, resulting in an increase in a resonant action between the two natural frequencies. Therefore there is a problem that road noise is deteriorated.

### DISCLOSURE OF THE INVENTION

An object of the present invention is to provide a tire wheel which can be lightened without suffering deterioration of road noise.

In order to achieve the above object, the present invention provides a tire wheel having a disk and a rim for mounting a pneumatic tire joined to a peripheral edge of the disk, the rim having a rim body joined to the disk and rim flanges joined to both width direction sides of the rim body, the disk being offset to one side with respect to a width direction center of the rim,

wherein the rim body has a rim body portion extending from a join position between the disk and the rim body to a boundary position between the rim body and the rim flange on the other side, the rim body portion consisting of three equal sections into which the rim body portion is equally divided along a center axis of rotation of the wheel, the equal section positioned nearer to the rim flange on the other side being thinner in average rim thickness.

According to the present invention mentioned above, the rim body portion which greatly affects the natural frequency of the wheel is not reduced averagely in thickness but the equal section located closer to the rim flange on the other side is thinner unlike the prior art wheel, thereby allowing a spring constant of the rim body portion to be maintained in the same level as or greater than that before lightening. As a result, the natural frequency of the wheel does not move to a lower frequency band while lightening the wheel.

An increase in a resonant action between the natural frequencies of the wheel and pneumatic tire, therefore, can be avoided. Accordingly, the lightening of the wheel can be achieved without deteriorating road noise.

### BRIEF DESCRIPTION OF THE DRAWINGS

FIG. 1 is a half cross-sectional view showing an embodiment of a tire wheel according to the present invention in a wheel-radial cross section taken along a plane which passes through the center axis of rotation of the wheel.

FIG. 2 is an enlarged cross-sectional view showing a join position between the disk and rim body of the wheel in FIG. 1.

FIG. 3 is an enlarged cross-sectional view showing a boundary position between the rim body and other rim flange of the wheel in FIG. 1.

### BEST MODES FOR CARRYING OUT THE INVENTION

The embodiment of the present invention will be described in detail below with reference to the drawings.

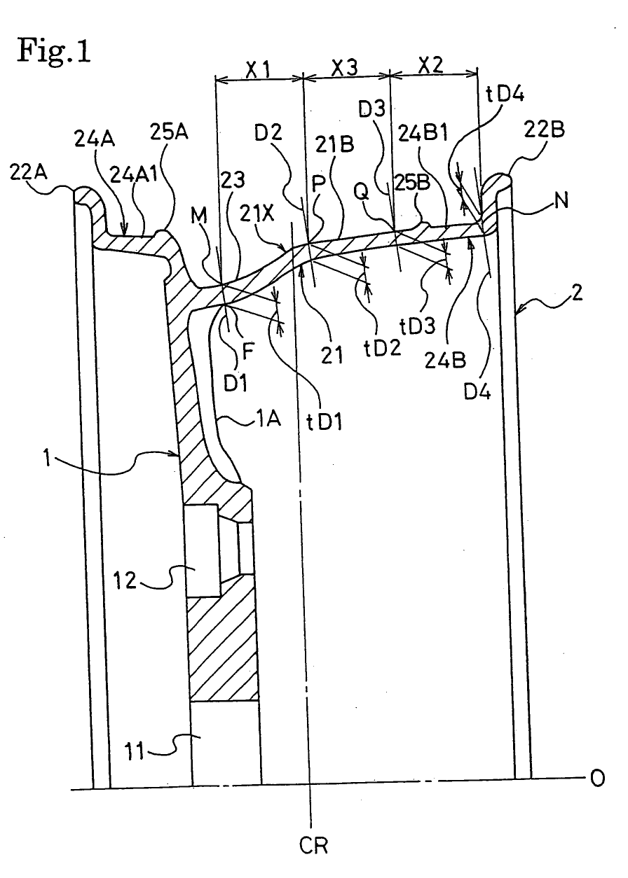

FIG. 1 shows a tire wheel embodying the present invention, in which reference numeral 1 denotes a disk and reference numeral 2 denotes a rim. The disk 1 includes a center portion, which has a hub hole 11 for receiving a hub of an axle. The disk 1 has a plurality of bolt holes 12 for securing the disk 1 to a vehicle in a part surrounding the hub hole 11, the bolt holes 12 being placed in a given interval along the circumferential direction of the disk 1.

The rim 2 for mounting a pneumatic tire is joined to the peripheral edge of the disk 1. The rim 2 comprises a cylindrical rim body 21 joined to the disk 1, and annular rim flanges 22A and 22B joined to both width direction sides of the rim body 21. The rim body 21 includes a well 23 which is concave in shape, and bead seats 24A and 24B which extend from both sides of the well 23, and the peripheral edge of the disk 1 which is offset to one side relative to the width direction center line CR of the rim 2 is joined to the well 23. Humps 25A and 25B annularly protrude on the radially outer surfaces 24A1 and 24B1 of the bead seats 24A and 24B along the circumferential direction of the wheel.

The rim body 21 has a rim body portion 21X extending from a join position M between the disk 1 and rim body 21 to a boundary position N between the rim body 21 and the rim flange 22B on the other side, and the rim body portion 21X is equally divided into three equal sections along the center axis O of rotation of the wheel. The three equal sections consist of a disk side equal section X1 joined to the disk 1, a flange side equal section X2 joined to the rim flange 22B on the other side, and a middle equal section X3 between the disk side equal section X1 and the flange side equal section X2. The disk side equal section X1 is the thickest and the flange side equal section X2 is the thinnest in average rim thickness, and the equal section positioned nearer to the rim flange 22b on the other side is thinner.

The rim body portion 21X which extends laterally from the peripheral edge of the disk 1 as mentioned above and greatly affects the natural frequency of the wheel is not reduced averagely in thickness but the equal section positioned nearer to the rim flange on the other side is thinner unlike the prior art wheel, thereby allowing a spring constant of the rim body portion 21X to be maintained in the same level as that before lightening while lightening the wheel.

Thus, the natural frequency of the wheel can be prevented from moving into a lower frequency band, and is not close to the natural frequency of a pneumatic tire assembled to the wheel. As a result, an increase in a resonant action between the natural frequencies of the wheel and pneumatic tire can be avoided. Accordingly, the lightening of the wheel can be achieved without suffering deterioration of road noise.

In the present invention, the three equally divided equal sections X1, X2 and X3 have average rim thicknesses t₁, t₂ and t₃, and the difference between the average rim thicknesses of at least one pair of adjacent equal sections and preferably between the average rim thicknesses of the equal sections adjacent to each other may be 0.5 mm or more. By ensuring the difference of 0.5 mm or more like this, the natural frequency of the wheel can be moved to a higher frequency band, and therefore, a resonant action between the wheel and pneumatic tire is more suppressed to thereby achieve further reduction of road noise. The upper limit of the difference may be 5 mm in terms of strength and lightening of the wheel.

The average rim thickness t₁ of the disk side equal section X1 may be 3 mm to 8 mm, and the average rim thickness t₂ of the flange side equal section X2 may be 2 mm to 3 mm. If the average rim thicknesses are lower than the above range, it is difficult to maintain the strength of the wheel, and if the average rim thicknesses exceed the above range, lightening of the wheel is prevented.

Preferably, the rim body portion 21X is arranged, as shown in FIG. 1, such that the rim thickness of the rim body portion 21X is continuously thinner as getting closer to the rim flange 22B on the other side.

In the present invention, the join position M between the disk 1 and the rim body 21, and the boundary position N between the rim body portion 21 and the rim flange B on the other side are determined as follows.

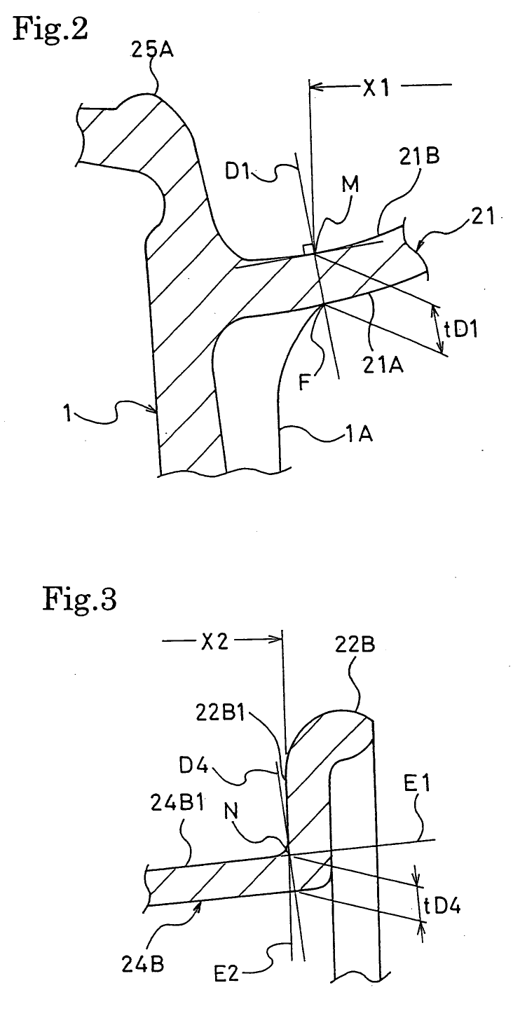

The join position M is, as shown in FIG. 2, an intersection point between the radially outer surface 21B of the rim body 21 and a normal D1 in a wheel-radial cross section taken along a plane which passes through the center axis O of rotation of the wheel, the normal D1 being a normal line drawn to the radially outer surface 21B from an intersection or connection point F between the inner surface 1A of the disk 1 facing to the side of the rim flange 22B on the other side and the radially inner surface 21A of the rim body 21.

The boundary position N is, as shown in FIG. 3, an intersection point between an extension line E1 of the radially outer surface 24B1 of the bead seat 24B positioned on the rim flange 22B side of the hump 25B and an extension line E2 of the inner side surface portion 22B1 of the rim flange 22B orthogonal to the center axis O of rotation of the wheel in a wheel-radial cross section taken along a plane which passes through the center axis O of rotation of the wheel.

The average rim thicknesses t₁, t₂ and t₃ of the equal sections X1, X2 and X3 are determined in the following expressions, wherein, in the case that the radially outer surface 21B of the rim body 21 is a curved line in cross section, tD1, tD2 and tD3 are thicknesses measured along respective normal lines D1, D2 and D3 drawn to respective positions M, P and Q which are located on the radially outer surface 21B and divide the equal sections X1, X2 and X3, and in the case that the radially outer surface 21B is straight in cross section, tD1, tD2 and tD3 are thicknesses measured along respective lines perpendicular to respective positions M, P and Q, and tD4 is a thickness measured from the boundary position N along a perpendicular line D4 drawn to the extension line E1.
t₁=(tD1+tD2)/2
t₂=(tD3+tD4)/2
t₃=(tD2+tD3)/2

The present invention is preferably applicable to wheels used particularly for a pneumatic tire for passenger cars.

### EXAMPLE

Prepared were wheels of the present invention 1 to 4 and prior art 1 and 2 having the same rim size of 15×6½, the present invention wheels 1 to 4 and prior art wheels 1 and 2 having a construction shown in FIG. 1, the average rim thicknesses of the disk side equal section, middle equal section and flange side equal section thereof being shown in Table 1.

Evaluation tests for weight and road noise were conducted on each test wheel in accordance with the following measurement methods. The results shown in Table 1 were obtained.

Weight

The weight of each test wheel was measured. The measurement result was evaluated by an index number, with the index number of the prior art wheel 1 being 100. The smaller the index number was, the lighter the wheel.

Road Noise

Each group of test wheels on which tires having a tire size of 195/60R15 were mounted with their air pressure being 200 kPa and were attached to a front-wheel-drive passenger car with a displacement of 2 liters, and a feeling test was conducted by five test drivers in a test course with the passenger car driven by each test driver. Each result of the feeling test was evaluated by 5-point method, and the mark of road noise was an average value of evaluation by the five test drivers. The greater the value was, the lower the road noise.

TABLE 1

| | Dark Side | Middle | Flange | | |
|---|---|---|---|---|---|
| | Equal | Equal | Side Equal | | |
| | Section | Section | Section | | |
| | Average | Average | Average | | |
| | Rim | Rim | Rim | Weight | |
| | thickness | thickness | thickness | (index number | Road |
| | (mm) | (mm) | (mm) | indication) | Noise |
| Prior Art | 4 | 4 | 4 | 100 | 3 |
| Wheel 1 | | | | | |
| Prior Art | 3 | 3 | 3 | 75 | 2 |
| Wheel 2 | | | | | |
| Present | 3.3 | 3 | 2.7 | 75 | 3.2 |
| Invention | | | | | |
| Wheel 1 | | | | | |
| Present | 3.5 | 3.2 | 2.7 | 76 | 3.4 |
| Invcention | | | | | |
| Wheel 2 | | | | | |
| Present | 3.5 | 3 | 2.5 | 75 | 4 |
| Invention | | | | | |
| Wheel 3 | | | | | |
| Present | 5 | 3.2 | 2.7 | 80 | 4 |
| Invention | | | | | |
| Wheel 4 | | | | | |

As can be seen from Table 1, the wheels of the present invention do not deteriorate road noise unlike the prior art wheel 2 which reduced weight, while the wheels of the present invention are lighter than the prior art wheel 1.

As illustrated above, according to the present invention, in three equal sections into which the rim body portion is equally divided along the center axis of rotation of the wheel, the equal section positioned nearer to the side of the rim flange on the other side has a thinner average rim thickness, thereby allowing the wheel to be lightened without suffering deterioration of road noise.

### INDUSTRIAL APPLICABILITY

The tire wheel of the present invention having the aforementioned excellent effect can be employed very effectively as a tire wheel which is to be attached to a vehicle.

1. A tire wheel having a disk and a rim for mounting a pneumatic tire joined to a peripheral edge of the disk, the rim having a rim body joined to the disk and rim flanges joined to both width direction sides of the rim body, the disk being offset to one side with respect to a width direction center of the rim,
wherein the rim body has a rim body portion extending from a join position between the disk and the rim body to a boundary position between the rim body and the rim flange on the other side, the rim body portion consisting of three equal sections into which the rim body portion is equally divided along a center axis of rotation of the wheel, the equal section positioned nearer to the rim flange on the other side being thinner in average rim thickness.

2. A tire wheel according to claim 1, wherein the three equally divided equal sections have average rim thicknesses, a difference between the average rim thicknesses of at least one pair of adjacent equal sections being 0.5 mm or more.

3. A tire wheel according to claim 1, wherein the three equally divided equal sections consist of a disk side equal section joined to the disk, a flange side equal section joined to the rim flange on the other side, and a middle equal section located between the flange side equal section and the disk side equal section, the average rim thickness of the disk side equal section being 3 mm to 8 mm, the average rim thickness of the flange side equal section being 2 mm to 3 mm.

4. A tire wheel according to claim 1, wherein the rim body portion is thinner in rim thickness toward the rim flange on the other side.

5. A tire wheel according to claim 4, wherein the rim body portion is thinner in rim thickness as getting closer to the rim flange on the other side.
